(19) United States
(12) Patent Application Publication
(10) Pub. No.: US 2025/0194758 A1
(43) Pub. Date: Jun. 19, 2025

(54) COUPLING MEMBER ASSEMBLY, AND WEARABLE ELECTRONIC DEVICE INCLUDING COUPLING MEMBER

(71) Applicant: Samsung Electronics Co., Ltd., Suwon-si (KR)

(72) Inventor: Jinwook KIM, Suwon-si (KR)

(21) Appl. No.: 19/071,199

(22) Filed: Mar. 5, 2025

Related U.S. Application Data
(63) Continuation of application No. PCT/KR2023/012919, filed on Aug. 30, 2023.

(30) Foreign Application Priority Data
Oct. 11, 2022 (KR) 10-2022-0129627
Nov. 4, 2022 (KR) 10-2022-0145919

(51) Int. Cl. A44C 5/14; F16B 1/00

(52) U.S. Cl. CPC A44C 5/147; F16B 1/00; F16B 2200/83

(57) ABSTRACT

A wearable electronic device is provided. The wearable electronic device includes a housing including a link bar, a coupling member connected to the housing, a first magnet connected to the link bar, a second magnet connected to the coupling member and attached to the first magnet, and a magnet case connected to the coupling member, surrounding at least a portion of the second magnet, and including a protrusion configured to contact the link bar.

### CROSS-REFERENCE TO RELATED APPLICATION(S)

This application is a continuation application, claiming priority under 35 U.S.C. § 365(c), of an International application No. PCT/KR2023/012919, filed on Aug. 30, 2023, which is based on and claims the benefit of a Korean patent application number 10-2022-0129627, filed on Oct. 11, 2022, in the Korean Intellectual Property Office, and of a Korean patent application number 10-2022-0145919, filed on Nov. 4, 2022, in the Korean Intellectual Property Office, the disclosure of each of which is incorporated by reference herein in its entirety.

### BACKGROUND

### 1. Field

The disclosure relates to a coupling member assembly and a wearable electronic device including a coupling member.

### 2. Description of Related Art

With the advancement of information and communication technologies and semiconductor technologies, various functions are being integrated into a single portable electronic device. For example, an electronic device can implement not only communication functions but also entertainment functions such as gaming, multimedia functions such as music and video playback, communication and security functions for mobile banking, as well as scheduling and electronic wallet functions. As electronic and communication technologies have advanced, these electronic devices have become miniaturized and lightweight enough to be used comfortably even when worn on the body.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a coupling member assembly and a wearable electronic device including a coupling member.

Additional aspects will be set forth in part in the description which follows and, in part, will be apparent from the description, or may be learned by practice of the presented embodiments.

In accordance with an aspect of the disclosure, a wearable electronic device is provided. The wearable electronic device includes a housing including a link bar, a coupling member connected to the housing, a first magnet connected to the link bar, a second magnet connected to the coupling member and attached to the first magnet, and a magnet case connected to the coupling member, surrounding at least a portion of the second magnet, and including a protrusion configured to contact the link bar.

In accordance with another aspect of the disclosure, an electronic device is provided. The electronic device includes a housing including a side bezel structure, a protruded part extending from the side bezel structure, and a link bar extending from the protruded part, a coupling member comprising a groove region including a groove accommodating at least a portion of the link bar, and an end region extending from the groove region and configured to be inserted into an empty space formed by the side bezel structure, the protruded part, and the link bar, a first magnet disposed on the link bar, a second magnet disposed on the end region and configured to attract the first magnet, and a magnet case disposed on the end region and surrounding at least a portion of the second magnet.

In accordance with another aspect of the disclosure, a coupling member assembly is provided. The coupling member assembly includes a coupling member comprising a groove region including a groove and an end region extending from the groove region, a magnet case disposed within the end region, the magnet case including a protrusion protruding toward the groove, and a strap magnet disposed within the end region, at least a portion of the strap magnet being surrounded by the magnet case.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a front perspective view of an electronic device according to an embodiment of the disclosure;

FIG. 2 is a rear perspective view of the electronic device of FIG. 1 according to an embodiment of the disclosure;

FIG. 3 is an exploded perspective view of an electronic device according to an embodiment of the disclosure;

FIG. 4 is a front view of an electronic device according to an embodiment of the disclosure;

FIG. 5 is a side view of a coupling member according to an embodiment of the disclosure;

FIG. 6 is a front perspective view illustrating the connection between a housing and a coupling member according to an embodiment of the disclosure;

FIG. 7 is a rear perspective view illustrating the connection between a housing and a coupling member according to an embodiment of the disclosure;

FIG. 8 is an exploded perspective view of an electronic device including a first magnet, a magnet cover, and a housing according to an embodiment of the disclosure;

FIG. 9 is a rear perspective view of a coupling member assembly according to an embodiment of the disclosure;

FIG. 10 is an exploded perspective view of a coupling member assembly according to an embodiment of the disclosure;

FIG. 11A is a side view of an electronic device in a coupled state according to an embodiment of the disclosure;

FIG. 11B is a side view of an electronic device in a separated state according to an embodiment of the disclosure;

FIG. 12 is a cross-sectional perspective view of an electronic device in a coupled state according to an embodiment of the disclosure; and

FIGS. 13A, 13B, and 13C are diagrams illustrating the coupling or separation of a coupling member with respect to a housing according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The electronic device according to various embodiments of the disclosure may be one of various types of devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in the various embodiments of the disclosure, the term “module” may include a unit implemented in hardware, software, or firmware, and may interchangeably be used with other terms, for example, “logic,” “logic block,” “portion,” or “circuitry”. A module may be a single integral component, or a minimum unit or portion thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or further, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

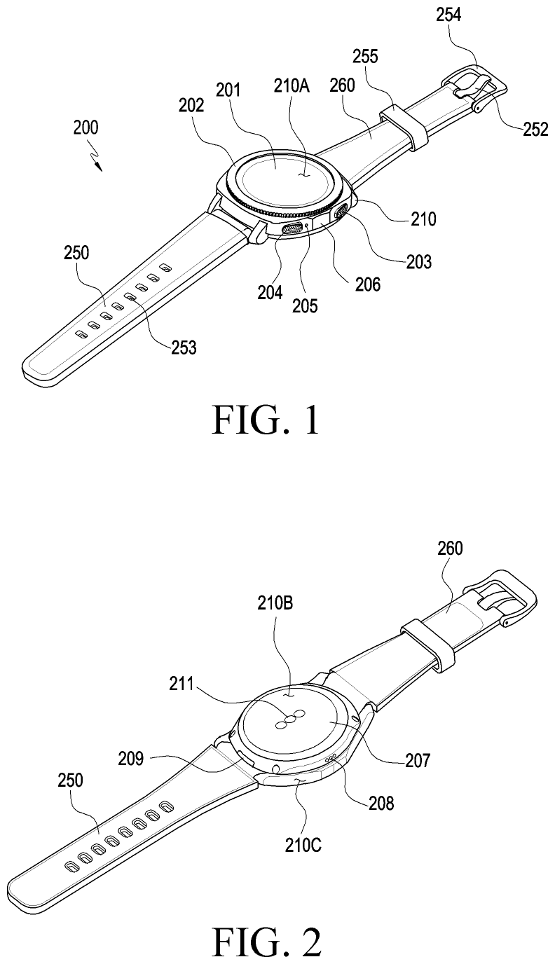

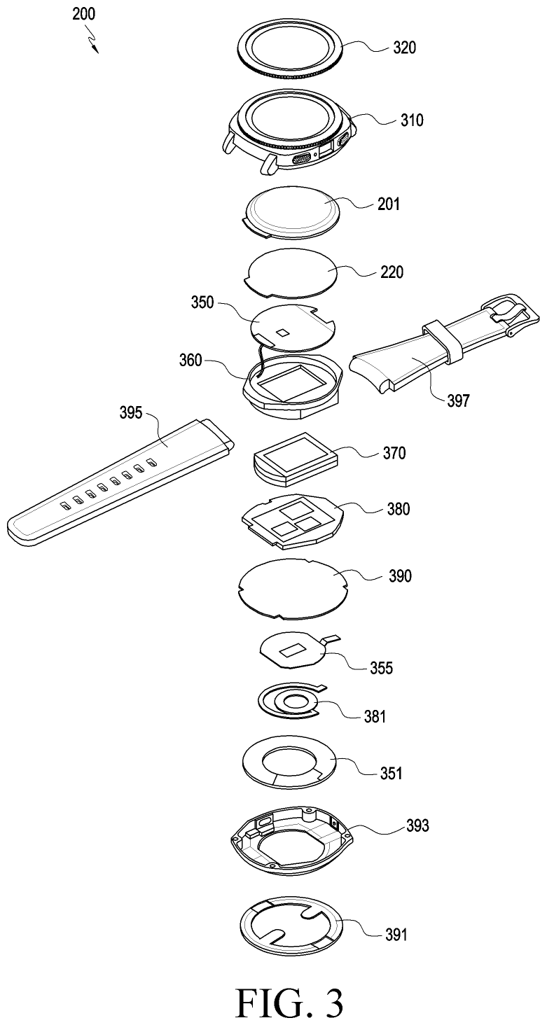

FIG. 1 is a front perspective view illustrating an electronic device according to an embodiment of the disclosure. FIG. 2 is a rear perspective view illustrating the electronic device of FIG. 1 according to an embodiment of the disclosure.

Referring to FIGS. 1 and 2, an electronic device 200 is in the form of a watch, and a user may wear the electronic device 200. For example, the electronic device 200 may be a smart watch wearable around a user's wrist or a wearable electronic device.

According to an embodiment, the electronic device 200 may include a housing 210, which comprises a first surface (or front surface) 210A, a second surface (or rear surface) 210B, and a side surface 210C surrounding a space between the first surface 210A and the second surface 210B, and coupling members 250 and 260, which are connected to at least a portion of the housing 210 and are configured to detachably fasten the electronic device 200 to a part of a user's body (e.g., wrist, ankle, etc.).

According to an embodiment, the housing 210 may refer to a structure that forms at least a portion of the first surface 210A, the second surface 210B, and the side surface 210C. According to an embodiment, the first surface 210A may be formed by a front plate 201 (e.g., a glass plate or polymer plate including various coating layers) that is at least partially substantially transparent. The second surface 210B may be formed by a substantially opaque rear plate 207. The rear plate 207 may be formed, for example, of coated or tinted glass, ceramic, polymer, metal (e.g., aluminum (Al), stainless steel (STS), magnesium (Mg), titanium (Ti)), or a combination of at least two of these materials. The side surface 210C may be formed by a side bezel structure (or “side member”) 206 coupled with the front plate 201 and the rear plate 207 and including metal and/or polymer. In some embodiments, the rear plate 207 and the side bezel structure 206 may be integrally formed and include the same material (e.g., a metal material such as aluminum). The coupling members 250 and 260 may be formed in various materials and forms. A woven fabric, leather, rubber, urethane, metal, ceramic, or a combination of at least two of these materials may be used to form an integrated type or multiple unit links that are movably connected to each other.

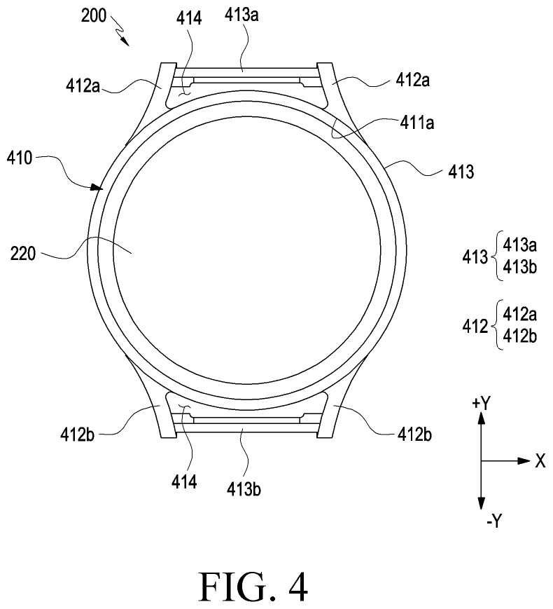

According to an embodiment, the electronic device 200 may include at least one of a display (e.g., display 220 of FIG. 3), an audio module 205 and 208, a sensor module 211, key input devices 202, 203, and 204, and a connector hole 209. In some embodiments, the electronic device 200 may omit at least one of the components (e.g., the key input devices 202, 203, and 204, the connector hole 209, or the sensor module 211) or may additionally include other components.

The display 220 may visually provide information to the outside of the electronic device 200 (e.g., to a user). The display 220 may include, for example, a display panel, a hologram device, or a projector, as well as a control circuit for controlling such devices. According to an embodiment, the display 220 may include a touch sensor configured to detect touch or a pressure sensor configured to measure the intensity of force generated by the touch.

The display 220 may be visually exposed, for example, through a substantial portion of the front plate 201. The shape of the display 220 may correspond to the shape of the front plate 201 and may be in any of various shapes such as a circle, an oval, or a polygon. The display 220 may be combined with or arranged adjacent to a touch detection circuit, a pressure sensor capable of measuring the intensity (pressure) of a touch, and/or a fingerprint sensor.

The audio module 205 and 208 may convert a sound into an electrical signal or, conversely, convert an electrical signal into a sound. The audio module 205 and 208 may include a microphone hole 205 and a speaker hole 208. A microphone configured to obtain an external sound may be disposed in the microphone hole 205, and in some embodiments, a plurality of microphones may be arranged to detect the direction of a sound. The speaker hole 208 may be used as an external speaker or a receiver for calls. In some embodiments, the speaker hole 208 and the microphone hole 205 may be implemented as a single hole, or a speaker without a speaker hole 208 (e.g., a piezo speaker) may be included.

The sensor module 211 may generate an electrical signal or data value corresponding to an internal operation state of the electronic device 200 or external environmental state. The sensor module 211 may include, for example, a biometric sensor module (e.g., a heart rate monitor (HRM) sensor) disposed on the second surface 210B of the housing 210. The electronic device 200 may further include a sensor module (not shown), for example, at least one of a gesture sensor, gyro sensor, barometric sensor, magnetic sensor, accelerometer, grip sensor, color sensor, IR (infrared) sensor, biometric sensor, temperature sensor, humidity sensor, or illuminance sensor.

The key input devices 202, 203, and 204 may receive commands or data to be used by components of the electronic device 200 (e.g., a processor) from the outside of the electronic device 200 (e.g., a user). The key input devices 202, 203, and 204 may include a wheel key 202, which is disposed on the first surface 210A of the housing 210 and is rotatable in at least one direction, and/or side key buttons 203 and 204, which are disposed on the side surface 210C of the housing 210. The wheel key may have a shape corresponding to the shape of the front plate 201. In an embodiment, the electronic device 200 may omit some or all of the above-mentioned key input devices 202, 203, and 204. The omitted key input devices (e.g., key input devices 202, 203, and 204) may instead be implemented in other forms, such as soft keys on the display 220. The connector hole 209 may accommodate a connector (e.g., a USB connector) for transmitting and receiving power and/or data to/from an external electronic device, and another connector hole (not shown) may accommodate a connector for transmitting and receiving audio signals to/from an external electronic device. The electronic device 200 may further include, for example, a connector cover (not shown) that covers at least a portion of the connector hole 209 and blocks the entry of external foreign substances into the connector hole.

The coupling members 250 and 260 may be detachably coupled to at least a partial region of the housing 210 using connecting members. The coupling members 250 and 260 may include one or more of a fixing member 252, a fixing member fastening hole 253, a band guide member 254, or a band fixing ring 255. According to an embodiment, the coupling members 250 and 260 may be referred to as straps.

The fixing member 252 may be configured to allow the housing 210 and the coupling members 250 and 260 to be fastened to a part of the user's body (e.g., wrist, ankle, etc.). The fixing member fastening hole 253 may correspond to the fixing member 252 and enable the housing 210 and the coupling members 250 and 260 to be fastened to a part of the user's body. The band guide member 254 may be configured to limit the movement range of the fixing member 252 when the fixing member 252 is fastened to the fixing member fastening hole 253, thereby allowing the coupling members 250 and 260 to be secured in close contact with a part of the user's body. The band fixing ring 255 may limit the movement range of the coupling members 250 and 260 when the fixing member 252 is fastened to the fixing member fastening hole 253.

FIG. 3 is an exploded perspective view illustrating an electronic device according to an embodiment of the disclosure.

Referring to FIG. 3, an electronic device 200 may include a side bezel structure 310, a front plate 201, a display 320, a first antenna 350, a second antenna 351, a sensor module 355, a support member 360, a battery 370, a printed circuit board (PCB) 380 (e.g., a first printed circuit board), a flexible printed circuit board (FPCB) 381 (e.g., a second printed circuit board), a sealing member 390, a rear plate 393, a rear cover 391, and/or coupling members 395 and 397. At least one of components of the electronic device 200 may be the same as or similar to at least one of components of the electronic device 200 of FIG. 1 or 2, and redundant descriptions thereof will be omitted hereafter. The support member 360 may be disposed inside the electronic device 200 and may be connected to or integrally formed with the side bezel structure 310. The support member 360 may, for example, be formed of a metal material and/or a non-metal material (e.g., a polymer). The support member 360 may have the display 220 coupled to one side and a printed circuit board 380 coupled to the other side. The printed circuit board 380 and/or the flexible printed circuit board 381 may have a processor, memory, and/or interface mounted thereon.

According to an embodiment, the processor may include one or more of a central processing unit (CPU), an application processor, a graphic processing unit (GPU), a sensor processor, or a communication processor. According to an embodiment, the processor may execute software (e.g., a program) to control at least one other component (e.g., a hardware or software component) of the electronic device 200 connected to the processor and may perform various data processing or computations.

According to an embodiment, the memory may include, for example, volatile memory or non-volatile memory. The interface may include, for example, a high definition multimedia interface (HDMI), a universal serial bus (USB) interface, a secure digital (SD) card interface, and/or an audio interface. The interface may electrically or physically connect the electronic device 200 to an external electronic device and may include, for example, a USB connector, an SD card/multimedia card (MMC) connector, or an audio connector.

According to an embodiment, the side bezel structure 310 may function as an antenna for the electronic device 200. For example, a communication module (e.g., the communication module 190 of FIG. 1) may use the side bezel structure 310 to transmit wireless signals externally or receive wireless signals from the outside. According to an embodiment, the side bezel structure 310 may be electrically connected to the communication module 190 located on the printed circuit board 380. According to an embodiment, the configuration of the side bezel structure 310 may be entirely or partially identical to the configuration of an antenna module (e.g., the antenna module 197 of FIG. 1). According to an embodiment, the side bezel structure 310 may be entirely or partially identical to the configuration of the housing 210 of FIG. 1 or 2.

According to an embodiment, the battery 370 may be a device configured to supply power to at least one component of the electronic device 200 and may include, for example, a non-rechargeable primary battery, a rechargeable secondary battery, or a fuel cell. At least a portion of the battery 370 may be disposed, for example, substantially on the same plane as the printed circuit board 380. The battery 370 may be integrally disposed within the electronic device 200 or may be detachably disposed with respect to the electronic device 200.

According to an embodiment, the first antenna 350 may be disposed between the display 220 and the support member 360. The first antenna 350 may include, for example, a near field communication (NFC) antenna, a wireless charging antenna, and/or a magnetic secure transmission (MST) antenna. In an embodiment (e.g., FIG. 3), the first antenna 350 may be an NFC antenna. The first antenna 350 may, for example, perform near-field communication with an external device, wirelessly transmit and receive power necessary for charging, or transmit near-field communication signals or magnetic-based signals including payment data. In another embodiment, an antenna structure may be formed by a part of the side bezel structure 310 and/or the support member 360 or a combination thereof.

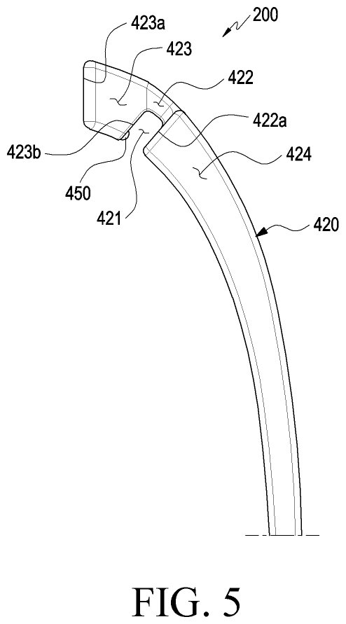

According to an embodiment, the second antenna 351 may be disposed between the printed circuit board 380 and the rear plate 393. The second antenna 351 may include, for example, a near field communication (NFC) antenna, a wireless charging antenna, and/or a magnetic secure transmission (MST) antenna. In an embodiment (e.g., FIG. 4), the second antenna 351 may be a wireless charging antenna. The second antenna 351 may, for example, perform near-field communication with an external device, wirelessly transmit and receive power necessary for charging, or transmit near-field communication signals or magnetic-based signals including payment data. In another embodiment, an antenna structure may be formed by a part of the side bezel structure 310 and/or the rear plate 393 or a combination thereof.

According to an embodiment, the sealing member 390 may be positioned between the side bezel structure 310 and the rear plate 393. The sealing member 390 may be configured to block moisture and foreign substances from entering into the space surrounded by the side bezel structure 310 and the rear plate 393 from the outside.

According to an embodiment, the rear cover 391 may be positioned below the rear plate 393. At least a portion of the rear cover 391 may be exposed to the outside of the electronic device 200. The rear cover 391 may cover at least a portion of the sensor module 355 and/or the flexible printed circuit board 381.

FIG. 4 is a front view of an electronic device according to an embodiment of the disclosure.

Referring to FIG. 4, an electronic device 200 may include a housing 410 and a display 220 accommodated in the housing 410. The configuration of the display 220 in FIG. 4 may be entirely or partially identical to the configuration of the display 320 in FIG. 3.

According to an embodiment, the housing 410 may include a side bezel structure 411. The configuration of the side bezel structure 411 in FIG. 4 may be entirely or partially identical to the configuration of the side bezel structure 310 in FIG. 3.

According to an embodiment, the housing 410 may include a protruded part 412 that protrudes from the side bezel structure 411. According to an embodiment, the protruded part 412 may be a part of the side bezel structure 411 that protrudes from a side 411a of the side bezel structure 411.

According to an embodiment, a plurality of protruded parts 412 may be provided. For example, the protruded part 412 may include at least one first protruded part 412a protruding in a second direction (+Y direction) and at least one second protruded part 412b protruding in a third direction (−X direction), which is opposite to the second direction (+Y direction). According to an embodiment, the first protruded part 412a and the second protruded part 412b may be substantially symmetrical with respect to a first direction (+X direction).

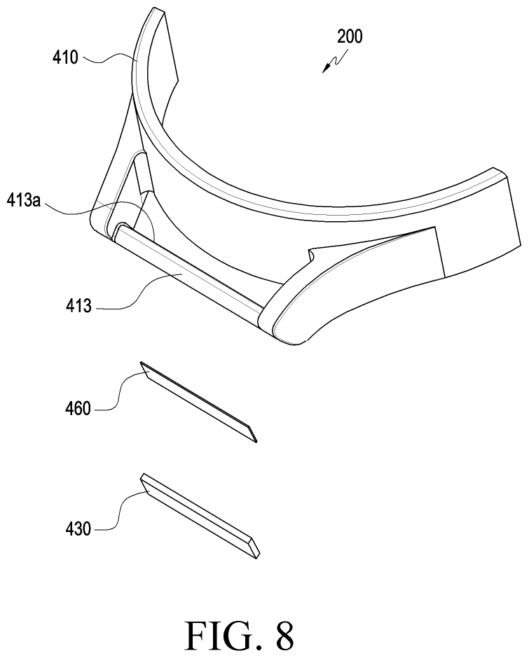

According to an embodiment, the housing 410 may include a link bar 413 extending from the protruded part 412. The link bar 413 may be a part of the protruded part 412 that protrudes from the protruded part 412. The housing 410 may be connected to a coupling member (e.g., coupling members 250 and 260 of FIG. 3 or coupling member 420 of FIG. 6) using the link bar 413. The link bar 413 may be connected or fastened to the coupling member (e.g., coupling member 420 of FIG. 6) using magnetic force and/or frictional force. According to an embodiment, the link bar 413 may be referred to as an end link or a bar.

According to an embodiment, a plurality of link bars 413 may be provided. For example, the link bars 413 may include a first link bar 413a connected to the first protruded part 412a and a second link bar 413b connected to the second protruded part 412b. The first link bar 413a may be arranged substantially parallel to the second link bar 413b. For instance, the link bars 413 may be arranged along a first direction (X-axis direction).

According to an embodiment, the housing 410 may form an empty space 414 surrounded by the side bezel structure 411, the protruded part 412, and the link bars 413. For example, at least a portion of the housing 410 (e.g., the side bezel structure 411, the protruded part 412, and the link bars 413) may have a closed-loop shape, and the space surrounded by the housing 410 may be referred to as the empty space 414. The empty space 414 may accommodate a part of the coupling member (e.g., coupling member 420 of FIG. 6).

According to an embodiment, the housing 410 may be formed of metal. For example, the housing 410 may include aluminum, stainless steel, magnesium, and/or titanium.

According to an embodiment, the side bezel structure 411, the protruded part 412, and the link bar 413 may be integrally formed. For instance, the side bezel structure 411, the protruded part 412, and the link bar 413 may include the same material. According to an embodiment, the side bezel structure 411, the protruded part 412, and the link bar 413 may be manufactured using a cutting process.

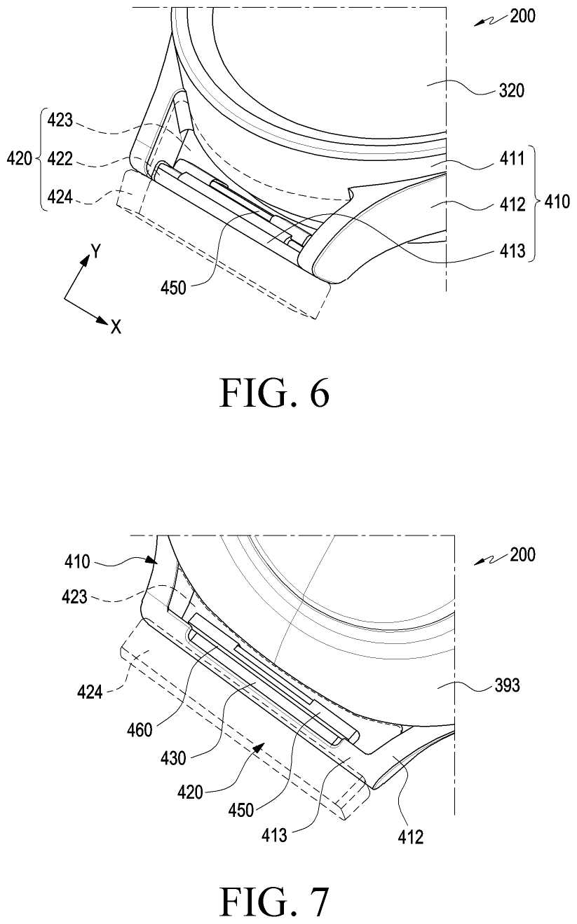

FIG. 5 is a side view of an electronic device including a coupling member according to an embodiment of the disclosure.

Referring to FIG. 5, an electronic device 200 may include a coupling member 420 and a magnet case 450 mounted on the coupling member 420. The configuration of the coupling member 420 in FIG. 5 may be entirely or partially identical to the configuration of the coupling members 250 and 260 in FIGS. 1 and 2 and/or the coupling members 395 and 397 in FIG. 3.

According to an embodiment, the coupling member 420 may be connected or fastened to the housing 410. For example, the coupling member 420 may include a groove region 422 having a groove 421. The groove 421 of the coupling member 420 may accommodate a part (e.g., the link bar 413 in FIG. 4) of the housing 410 in FIG. 4. By the link bar 413 being inserted into the groove 421, the coupling member 420 may be coupled to the housing 410 based on the frictional force between the link bar 413 and the coupling member 420. The groove 421 may also be referred to as a recess. For example, the groove 421 may be an empty space defined by a surface 422a of the groove region 422. According to an embodiment, the groove region 422 may be part of the coupling member 420 in which the groove 421 is formed. For instance, the width of the groove region 422 may be narrower than that of other portions of the coupling member 420 (e.g., end region 423 or fastening region 424).

According to an embodiment, the coupling member 420 may include an end region 423. The end region 423 may be part of the coupling member 420 extending from the groove region 422. The end region 423 may be accommodated within the empty space of the housing 410 (e.g., the empty space 414 of FIG. 4). According to an embodiment, when the coupling member 420 is coupled to the housing 410, the end region 423 may be surrounded by the side bezel structure 411, the protruded part 412, and the link bar 413. According to an embodiment, the end region 423 may contact at least a portion of the housing 410. For example, a first surface 423a of the end region 423 may contact the side bezel structure 411, and a second surface 423b, opposite to the first surface 423a, may contact the link bar 413.

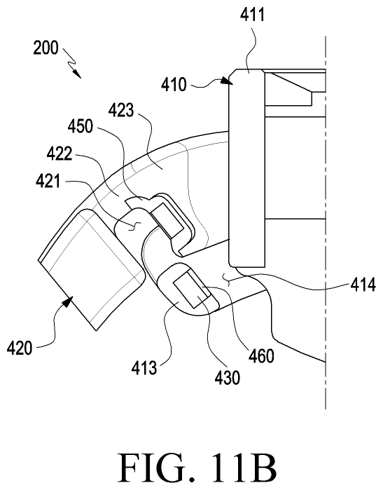

According to an embodiment, the coupling member 420 may accommodate components (e.g., second magnet 440 and the magnet case 450 of FIG. 10) for enhancing the coupling force between the housing 410 and the coupling member 420. For example, the coupling member 420 may include a groove or space to accommodate a second magnet 440 and/or the magnet case 450.

According to an embodiment, the coupling member 420 may include a fastening region 424. The fastening region 424 may be part of the coupling member 420 extending from the groove region 422. The fastening region 424 may surround at least a portion of a user's body (e.g., a wrist). According to an embodiment, the groove region 422, the end region 423, and the fastening region 424 may be integrally formed.

According to an embodiment, the coupling member 420 may be made of an elastic material. For example, the coupling member 420 may include silicone and/or fluoroelastomers (FKM).

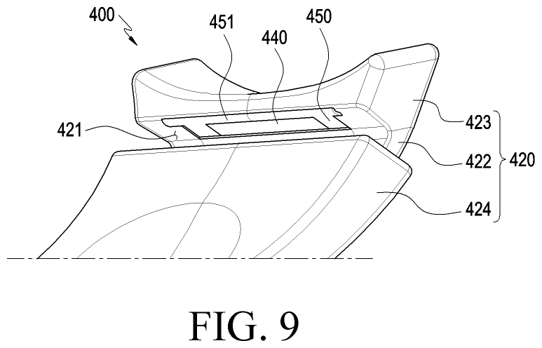

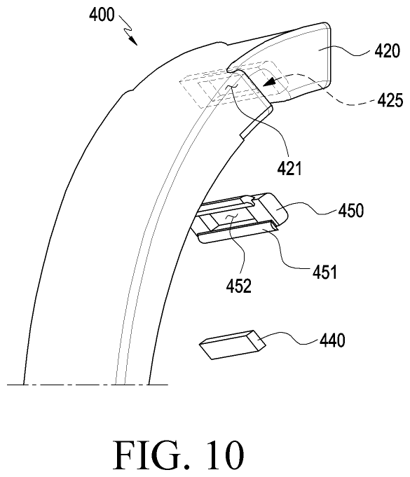

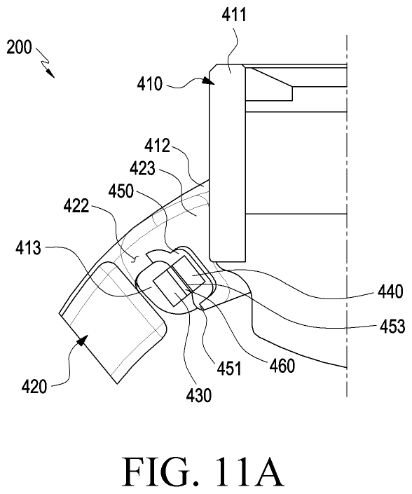

FIG. 6 is a front perspective view illustrating the connection between a housing and a coupling member according to an embodiment of the disclosure. FIG. 7 is a rear perspective view illustrating the connection between a housing and a coupling member according to an embodiment of the disclosure. FIG. 8 is an exploded perspective view of an electronic device including a first magnet, a magnet cover, and a housing according to an embodiment of the disclosure. FIG. 9 is a rear perspective view of a coupling member assembly according to an embodiment of the disclosure. FIG. 10 is an exploded perspective view of an electronic device including a second magnet, a magnet case, and a coupling member according to an embodiment of the disclosure.

Referring to FIGS. 6 to 10, an electronic device 200 may include a housing 410 that accommodates a display 320 (e.g., the display 320 of FIG. 3), a coupling member 420, a first magnet 430, a second magnet 440, and a magnet case 450. The configurations of the housing 410, coupling member 420, and magnet case 450 shown in FIGS. 6, 7, 8, 9, and/or 10 may be entirely or partially identical to the configurations of the housing 410, coupling member 420, and magnet case 450 shown in FIGS. 4 and/or 5.

According to an embodiment, the housing 410, along with a rear plate 393 (e.g., the rear plate 393 of FIG. 3) and the display 320, may form the exterior of the electronic device 200.

According to an embodiment, the housing 410 may be detachably connected to the coupling member 420. For example, the housing 410 may be connected or fastened to the coupling member 420 using frictional force and/or magnetic force.

According to an embodiment, the housing 410 may contact the coupling member 420 and the magnet case 450 attached to the coupling member 420. According to an embodiment, the frictional force between the housing 410 (e.g., a link bar 413) and the coupling member 420, and/or the frictional force between the housing 410 (e.g., the link bar 413) and the magnet case 450 may prevent or reduce the detachment of the coupling member 420 from the housing 410 while the coupling member 420 remains coupled to the housing 410.

According to an embodiment, the coupling member 420 may be attached to the housing 410 based on the magnetic field generated between the first magnet 430 connected to the housing 410 and the second magnet 440 connected to the coupling member 420.

According to an embodiment, the first magnet 430 may be disposed within the housing 410. For example, the first magnet 430 may be positioned within a link bar 413 of the housing 410. For instance, an inner surface of the link bar 413 and a magnet cover 460 may prevent the first magnet 430 from being exposed externally. According to an embodiment, the first magnet 430 may be connected to the housing 410 using the magnet cover 460. The magnet cover 460 may surround at least a portion of the first magnet 430. By being surrounded by the magnet cover 460, the first magnet 430 may have its breakage and paramagnetization reduced. According to an embodiment, the first magnet 430 may be referred to as a housing magnet.

According to an embodiment, the second magnet 440 may be positioned within the coupling member 420. For example, the second magnet 440 may be located within an end region 423 of the coupling member 420. According to an embodiment, the second magnet 440 may be arranged on a receiving portion 425 formed in the end region 423. According to an embodiment, the second magnet 440 may be referred to as a strap magnet.

According to an embodiment, the second magnet 440 may be connected to the coupling member 420 using the magnet case 450. For example, the second magnet 440 may be at least partially surrounded by the magnet case 450. By being surrounded by the magnet case 450, the second magnet 440 may have its breakage and paramagnetization reduced. According to an embodiment, the first magnet 430 and the second magnet 440 may be arranged substantially parallel to each other. For instance, the first magnet 430 and the second magnet 440 may be arranged along a first direction (e.g., the X-axis direction of FIG. 4) in which the link bar 413 is aligned.

According to an embodiment, the second magnet 440 may be configured to attach to the first magnet 430. For example, the second magnet 440 may attract the first magnet 430. The first magnet 430 may generate a magnetic field to provide an attractive force with the second magnet 440 positioned in the coupling member 420. For instance, the first magnet 430 and the second magnet 440 may have different polarities in positions when positioned to face each other.

According to an embodiment, the structure of the first magnet 430 and/or the second magnet 440 may be designed selectively. While this disclosure illustrates the first magnet 430 and the second magnet 440 as integrated structures, the structure of the first magnet 430 and the second magnet 440 is not limited thereto. For example, in an embodiment (not shown), the first magnet 430 and/or the second magnet 440 may include a plurality of spaced-apart magnets.

According to an embodiment, the magnet case 450 may reduce the paramagnetization of the second magnet 440 caused by thermal molding. For example, the second magnet 440, along with the coupling member 420, may be manufactured using thermal molding (e.g., insert injection). According to an embodiment, the second magnet 440, the coupling member 420, and the magnet case 450 may be formed through an insert molding process. Manufacturing the electronic device 200 using insert injection may prevent the detachment of the second magnet 440 from the coupling member 420. Due to the heat generated during the thermal molding process, the magnetic material may be heated above its Curie temperature. The Curie temperature may be referred to as the magnetic temperature at which a ferromagnetic material transitions between a ferromagnetic state and a paramagnetic state or vice versa. For example, when the ferromagnetic second magnet 440 is heated above its Curie temperature, the second magnet 440 may transition to a paramagnetic state, resulting in a reduction of its coupling force with the housing 410 of the coupling member 420. According to an embodiment, the magnet case 450 may surround at least a portion of the second magnet 440. By being surrounded by the magnet case 450, the intensity of the heat transferred to the second magnet 440 may be reduced, thereby decreasing the temperature increase of the second magnet 440. As the magnet case 450 reduces the temperature increase of the second magnet 440, the coupling force between the coupling member 420 and the housing 410 in the electronic device 200 manufactured using the insert molding process may be maintained.

According to an embodiment, the magnet case 450 may be formed of metal. For example, the magnet case 450 may include aluminum and/or a physical vapor deposition (PVD) layer. According to an embodiment, the magnet case may be manufactured using physical vapor deposition (PVD). For instance, the magnet case 450 may be produced through evaporation and/or sputtering.

According to an embodiment, a portion of the magnet case 450 may be exposed to the outside of the coupling member 420. For example, the magnet case 450 may include a protrusion 451 that protrudes outward from the coupling member 420. According to an embodiment, the protrusion 451 may be arranged substantially parallel to the magnet(s) (e.g., the first magnet 430 and/or the second magnet 440). According to an embodiment, the protrusion 451 may be referred to as a protruding portion or a protruding region.

According to an embodiment, the protrusion 451 may provide a tactile feedback to the user. For example, when the coupling member 420 is fully attached to the housing 410, a sound may be generated due to friction between the protrusion 451 and the housing 410 (e.g., the link bar 413). The sound caused by the friction between the protrusion 451 and the housing 410 may allow the user to determine whether the coupling of the coupling member 420 to the housing 410 is complete or incomplete.

According to an embodiment, the magnet case 450 may include an accommodating space 452 configured to accommodate the second magnet 440. For example, the second magnet 440 may be surrounded by the magnet case 450 while being accommodated within the accommodating space 452. In this disclosure, for the purpose of explanation, the accommodating space 452 is illustrated as a groove structure; however, the shape of the magnet case 450 is not limited thereto. For instance, the magnet case 450 may be manufactured in a fluid state while surrounding the second magnet 440, and the accommodating space 452 may be an empty space formed within the magnet case 450. For example, the second magnet 440 may be prevented from being exposed to the outside by the magnet case 450.

According to an embodiment, the magnet case 450 may include a cover portion 453 to prevent the exposure of the second magnet 440. The cover portion 453 may be in contact with the link bar 413 and/or the magnet cover 460.

According to an embodiment (e.g., FIGS. 9 and 10), a coupling member assembly 400 may include the coupling member 420, the second magnet 440, and the magnet case 450. The coupling member assembly 400 may be a component (or assembly) in which the coupling member 420, the second magnet 440, and the magnet case 450 are provided as a single modularized part.

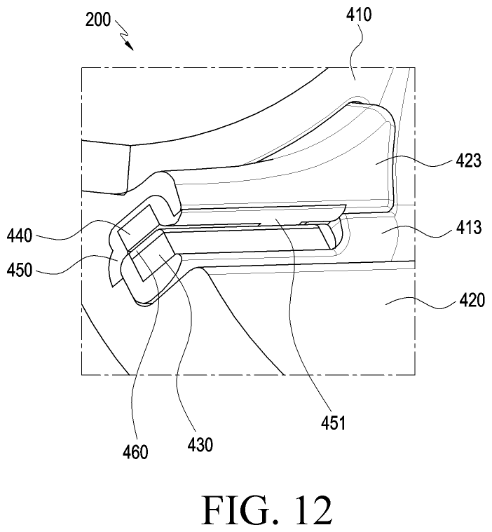

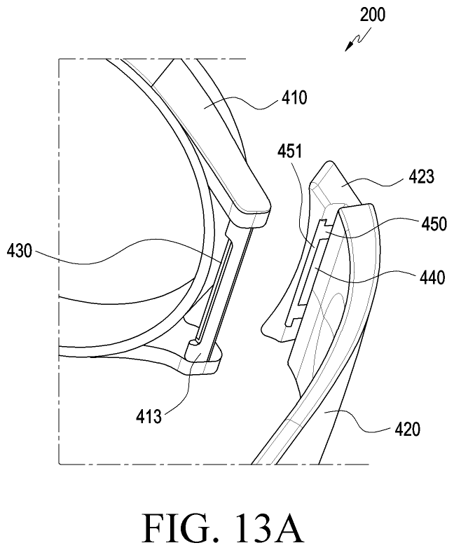

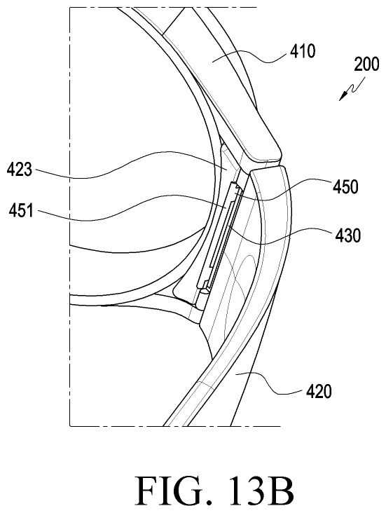

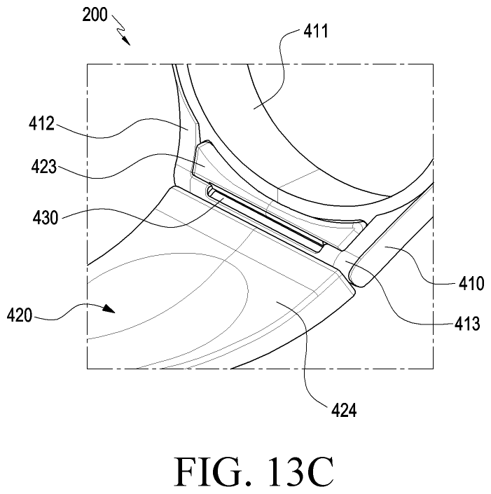

FIG. 11A is a side view of an electronic device in a coupled state according to an embodiment of the disclosure. FIG. 11B is a side view of an electronic device in a separated state according to an embodiment of the disclosure. FIG. 12 is a cross-sectional perspective view of an electronic device in a coupled state according to an embodiment of the disclosure. FIGS. 13A, 13B, and 13C are diagrams illustrating the coupling or separation of a coupling member with respect to a housing according to various embodiments of the disclosure.

Referring to FIGS. 11A, 11B, 12, and 13A to 13C, an electronic device 200 may include a housing 410, a coupling member 420, a first magnet 430, a second magnet 440, a magnet case 450, and a magnet cover 460. The configurations of the housing 410, the coupling member 420, the first magnet 430, the second magnet 440, the magnet case 450, and the magnet cover 460 shown in FIGS. 11A, 11B, 12, 13A, 13B, and/or 13C may be entirely or partially identical to the configurations of the housing 410, the coupling member 420, the first magnet 430, the second magnet 440, the magnet case 450, and the magnet cover 460 shown in FIGS. 6, 7, 8, 9, and/or 10.

According to an embodiment, the electronic device 200 may be coupled by magnetic force (e.g., attractive force) between the first magnet 430 and the second magnet 440, frictional force between the housing 410 and the coupling member 420, and frictional force between the housing 410 and the magnet case 450 and/or between the magnet case 450 and the magnet cover 460.

According to an embodiment (e.g., FIGS. 11B and 13A), the coupling member 420 may be connected or fastened to the housing 410. For example, an end region 423 of the coupling member 420 may be inserted into an empty space 414 surrounded by a side bezel structure 411, a protruded part 412, and a link bar 413 of the housing 410. The link bar 413 may be inserted into the groove 421 formed in a groove region 422 of the coupling member 420. Through the use of the empty space 414 and the groove 421 to connect the coupling member 420, the housing 410 and the coupling member 420 may form an interference fit. This interference fit enables the coupling member 420 to be connected to the housing 410 due to the frictional force generated between the housing 410 and the coupling member 420.

According to an embodiment, the coupled state of the electronic device 200 may refer to a state in which the first magnet 430, positioned within the link bar 413 of the housing 410, faces the second magnet 440, positioned within the end region 423 of the coupling member 420. The coupling member 420 may be connected to the housing 410 through the magnetic force (e.g., attractive force) generated between the first magnet 430 and the second magnet 440.

According to an embodiment, the housing 410 may have a shape configured to increase the coupling force with the coupling member 420. For example, a first width (w1) of the link bar 413 may be narrower than a second width (w2) of the protruded part 412. As the contact area increases, the frictional force between the housing 410 and the coupling member 420 may increase, thereby enhancing the coupling force of the coupling member 420 to the housing 410.

According to an embodiment (e.g., FIGS. 11A, 12, and 13B), the magnet case 450 may be in contact with the link bar 413 of the housing 410 and/or the magnet cover 460. The coupling member 420 may be connected to the housing 410 due to the frictional force between the magnet case 450 and the housing 410 (e.g., the link bar 413) and the frictional force between the magnet case 450 and the magnet cover 460.

According to an embodiment, in the coupled state of the electronic device 200, the protrusion 451 of the magnet case 450 may be in contact with the housing 410 (e.g., the link bar 413).

According to an embodiment (e.g., FIG. 13C), a user may separate the coupling member 420 from the housing 410 by applying force to the end region 423 of the coupling member 420. For example, as the end region 423 is disengaged, the second magnet 440 positioned within the end region 423 may become spaced apart from the first magnet 430. As the distance between the first magnet 430 and the second magnet 440 increases, the attractive force between the first magnet 430 and the second magnet 440 may decrease. By reducing the attractive force between the first magnet 430 and the second magnet 440, the force required to separate the coupling member 420 from the housing 410 may be reduced, thereby improving user convenience.

A wearable electronic device may remain in contact with the user's body for an extended period. To enhance the aesthetic appeal of the electronic device or suit different situations, there is an increasing demand for coupling members with various colors, materials, or shapes. Accordingly, research is ongoing to improve the convenience of connecting the housing and the coupling member. Furthermore, in wearable electronic devices, the need for a compact connection structure between the housing and the coupling member has been increasing for facilitating the miniaturization of the electronic device.

According to an embodiment of the disclosure, an electronic device may be provided, including a coupling member that can be easily attached to or detached from the housing.

According to another embodiment of the disclosure, the electronic device may include a coupling member that can be easily attached to or detached from the housing. When the coupling member is replaced, user convenience may be enhanced.

According to an embodiment of the disclosure, a wearable electronic device (e.g., the electronic device 200 of FIG. 1) may include a housing (e.g., the housing 410 of FIG. 4) comprising a link bar (e.g., the link bar 413 of FIG. 4); a coupling member (e.g., the coupling member 250, 260 of FIG. 1, the coupling member 395, 397 of FIG. 3, and/or the coupling member 420 of FIG. 5) configured to be connected to the housing; a first magnet (e.g., the first magnet 430 of FIG. 8) connected to the link bar; a second magnet (e.g., the second magnet 440 of FIG. 9) connected to the coupling member and configured to attach to the first magnet; and a magnet case connected to the coupling member and configured to surround at least a portion of the second magnet, the magnet case (e.g., the magnet case 450 of FIG. 10) including a protrusion (e.g., the protrusion 451 of FIG. 10) configured to contact the link bar.

The magnet case 450 may reduce the paramagnetization of the second magnet 440 caused by thermal molding. By reducing the temperature increase of the second magnet 440 through the magnet case 450, an increase in the temperature of the second magnet 440 up to its Curie temperature may be prevented, thereby maintaining the coupling force of the coupling member 420 to the housing 410 in the electronic device 200 manufactured using an insert molding process.

According to an embodiment, the magnet case may include an accommodating space (e.g., the accommodating space 452 of FIG. 10) configured to accommodate the second magnet, and a cover portion (e.g., the cover portion 453 of FIG. 11A) positioned on the second magnet. The cover portion may be configured to be positioned between the first magnet and the second magnet. By being positioned on the second magnet 440, the cover portion 453 may reduce the likelihood of damage to the second magnet 440.

According to an embodiment, the housing may include a side bezel structure (e.g., the side bezel structure 411 of FIG. 4) and a plurality of protruded parts (e.g., the protruded parts 412 of FIG. 4) extending from the side bezel structure. The link bar may be connected to the plurality of protruded parts.

According to an embodiment, the width of the link bar (e.g., the first width (w1) of FIG. 11B) may be narrower than the width of the plurality of protruded parts (e.g., the second width (w2) of FIG. 11B). Due to the shape of the link bar 413 and the protruded parts 412, the contact area between the housing 410 and the coupling member 420 may be increased. By increasing the contact area, the frictional force between the coupling member 420 and the housing 410 may also be increased.

According to an embodiment, the wearable electronic device may include a magnet cover (e.g., the magnet cover 460 of FIG. 8) that surrounds at least a portion of the first magnet. The magnet cover 460 may prevent damage to the first magnet 430.

According to an embodiment, the magnet cover may be positioned between the first magnet and the second magnet and configured to face the magnet case. Due to the frictional force between the magnet cover 460 and the magnet case 450, the coupling member 420 may be coupled to the housing 410.

According to an embodiment, the coupling member may include a groove region (e.g., the groove region 422 of FIG. 5) that includes a groove (e.g., the groove 421 of FIG. 5) configured to accommodate at least a portion of the link bar; an end region (e.g., the end region 423 of FIG. 5) extending from the groove region and configured to contact the housing; and a fastening region (e.g., the fastening region 424 of FIG. 5) extending from the groove region and configured to contact the user's body.

According to an embodiment, the second magnet and the magnet case may be positioned within the end region. By positioning the second magnet 440 and the magnet case 450 in the end region 423, the second magnet 440 and the magnet case 450 may be located adjacent to the link bar 413 of the housing 410.

According to an embodiment, the wearable electronic device may be configured such that at least a portion of the link bar is positioned between the end region and the fastening region.

According to an embodiment, the protrusion may be configured to generate a sound upon contact with the link bar when the coupling member is mounted on the housing. For example, the protrusion 451 may generate a sound to indicate whether the coupling member 420 is coupled to the housing 410.

According to an embodiment, the link bar may extend along a first direction. The first magnet and the second magnet may be arranged along the first direction.

According to an embodiment, the coupling member may include a receiving portion (e.g., the receiving portion 425 of FIG. 10) configured to accommodate the magnet case. By positioning the magnet case 450 within the receiving portion 425 of the coupling member 420, the stability of the magnet case 450 may be enhanced.

According to an embodiment, the second magnet, the coupling member, and the magnet case may be formed using an insert molding process. By forming the wearable electronic device through an insert molding process, the coupling force between the second magnet 440 and the coupling member 420 may be enhanced.

According to an embodiment, the coupling member may include silicone and/or fluoroelastomers (FKM).

According to an embodiment, the housing may include at least one of stainless steel, aluminum, or titanium.

According to an embodiment of the disclosure, the electronic device (e.g., the electronic device 200 of FIG. 1) may include a housing (e.g., the housing 410 of FIG. 4) comprising a side bezel structure (e.g., the side bezel structure 411 of FIG. 4), a protruded part (e.g., the protruded part 412 of FIG. 4) extending from the side bezel structure, and a link bar (e.g., the link bar 413 of FIG. 4) extending from the protruded part; a coupling member (e.g., the coupling member 420 of FIG. 5) comprising a groove region (e.g., the groove region 422 of FIG. 5) that includes a groove (e.g., the groove 421 of FIG. 5) configured to accommodate at least a portion of the link bar, and an end region (e.g., the end region 423 of FIG. 5) extending from the groove region and configured to be inserted into an empty space (e.g., the empty space 414 of FIG. 4) formed by the side bezel structure, the protrusion, and the link bar; a first magnet (e.g., the first magnet 430 of FIG. 8) disposed on the link bar; a second magnet (e.g., the second magnet 440 of FIG. 8) disposed on the end region and configured to attract the first magnet; and a magnet case (e.g., the magnet case 450 of FIG. 10) disposed on the end region and configured to at least partially surround the second magnet.

According to an embodiment, the electronic device may further include a magnet cover (e.g., the magnet cover 460 of FIG. 8) that surrounds at least a portion of the first magnet and is configured to face the magnet case.

According to an embodiment, the magnet case may include an accommodating space (e.g., the accommodating space 452 of FIG. 10) configured to accommodate the second magnet, and a cover portion (e.g., the cover portion 453 of FIG. 11A) positioned on the second magnet. The cover portion may be located between the first magnet and the second magnet.

According to an embodiment, the magnet case may include a protrusion (e.g., the protrusion 451 of FIG. 10) configured to contact at least a portion of the housing.

According to an embodiment of the disclosure, a coupling member assembly (e.g., coupling member assembly 400 of FIG. 9) may include a coupling member (e.g., the coupling member 420 of FIG. 9) comprising a groove region (e.g., the groove region 422 of FIG. 9) that includes a groove (e.g., the groove 421 of FIG. 9) and an end region (e.g., the end region 423 of FIG. 9) extending from the groove region; a magnet case disposed within the end region and comprising a protrusion (e.g., the protrusion 451 of FIG. 10) extending toward the groove; and a strap magnet disposed within the end region and at least partially surrounded by the magnet case (e.g., the second magnet 440 of FIG. 10).

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a housing including a link bar;
a coupling member connected to the housing;
a first magnet connected to the link bar;
a second magnet connected to the coupling member and attached to the first magnet; and
a magnet case connected to the coupling member, surrounding at least a portion of the second magnet, and including a protrusion configured to contact the link bar.

2. The wearable electronic device of claim 1,
wherein the magnet case further includes an accommodating space for accommodating the second magnet and a cover portion positioned on the second magnet, and
wherein the cover portion is further positioned between the first magnet and the second magnet.

3. The wearable electronic device of claim 1,
wherein the housing further includes a side bezel structure and a plurality of protruded parts extending from the side bezel structure, and
wherein the link bar is connected to the plurality of protruded parts.

4. The wearable electronic device of claim 3, wherein a first width of the link bar is narrower than a second width of the plurality of protruded parts.

5. The wearable electronic device of claim 1, further comprising:
a magnet cover surrounding at least a portion of the first magnet.

6. The wearable electronic device of claim 5, wherein the magnet cover is positioned between the first magnet and the second magnet and is configured to face the magnet case.

7. The wearable electronic device of claim 1, wherein the coupling member comprises:
a groove region including a groove accommodating at least a portion of the link bar;
an end region extending from the groove region and contacting the housing; and
a fastening region extending from the groove region and configured to contact a user's body.

8. The wearable electronic device of claim 7, wherein the second magnet and the magnet case are disposed within the end region.

9. The wearable electronic device of claim 7, wherein at least a portion of the link bar is configured to be positioned between the end region and the fastening region.

10. The wearable electronic device of claim 1, wherein the protrusion is further configured to generate a sound due to contact with the link bar when the coupling member is mounted on the housing.

11. The wearable electronic device of claim 1,
wherein the link bar extends along a first direction, and
wherein the first magnet and the second magnet are arranged along the first direction.

12. The wearable electronic device of claim 1, wherein the coupling member includes an accommodating portion configured to accommodate the magnet case.

13. The wearable electronic device of claim 1, wherein the second magnet, the coupling member, and the magnet case are formed using an insert molding process.

14. The wearable electronic device of claim 1, wherein the coupling member includes silicone or fluororubber.

15. The wearable electronic device of claim 1, wherein the housing further includes at least one of stainless steel, aluminum, or titanium.

16. A electronic device comprising:
a housing including side bezel structure, a protruded part extending from the side bezel structure, and a link bar extending from the protruded part;
a coupling member including a groove region that includes a groove accommodating at least a portion of the link bar, an end region extending from the groove region and configured to be inserted into an empty space formed by the side bezel structure, the protruded part, and the link bar;
a first magnet disposed on the link bar;
a second magnet disposed on the end region, and configured to attract the first magnet; and
a magnet case disposed on the end region and configured to at least partially surround the second magnet.

17. The electronic device of claim 16 further comprising:
a magnet cover surrounding at least a portion of the first magnet and is configured to face the magnet case.

18. The electronic device of claim 16,
wherein the magnet case further includes an accommodating space for accommodating the second magnet and a cover portion positioned on the second magnet, and
wherein the cover portion is further positioned between the first magnet and the second magnet.

19. The electronic device of claim 16, wherein the magnet case further includes a protrusion configured to contact at least a portion of the housing.

20. A coupling member assembly comprising:
a coupling member including a groove region that includes a groove and an end region extending from the groove region;
a magnet case disposed within the end region and comprising a protrusion extending toward the groove; and
a strap magnet disposed within the end region and at least partially surrounded by the magnet case.
